(19) United States
(12) Patent Application Publication
(10) Pub. No.: US 2021/0015053 A1
(43) Pub. Date: Jan. 21, 2021

(54) Trellis Attachment

(71) Applicants: Jack Steve Peterson, Knoxville, TN (US); Ryan M. Peterson, Knoxville, TN (US)

(72) Inventors: Jack Steve Peterson, Knoxville, TN (US); Ryan M. Peterson, Knoxville, TN (US)

(21) Appl. No.: 16/923,813

(22) Filed: Jul. 8, 2020

Related U.S. Application Data
(60) Provisional application No. 62/874,561, filed on Jul. 16, 2019.

(51) Int. Cl. A01G 9/02; A01G 9/12

(52) U.S. Cl. CPC A01G 9/023; A01G 9/12

(57) ABSTRACT

A trellis has a first ring circumnavigating a container, such as a level of pockets of a vertical gardening system. The first ring can be connected with arms to the container and one or more second rings can extend upwardly from an uppermost first ring to connect to second ring(s) which can extend above the first rings, possibly parallel thereto, and extend the second rings above the first rings and container.

### CLAIM OF PRIORITY

This application claims the benefit of U.S. Provisional Application No. 62/874,561 filed Jul. 16, 2019 which is incorporated herein by reference in its entirety.

### FIELD OF THE INVENTION

The present invention relates to a trellis attachment for use with plant containers of various constructions, and more particularly a trellis attachment configuration useful with plant towers such as those shown in U.S. Pat. No. 9,521,811.

### BACKGROUND OF THE INVENTION

The applicant's plant tower, U.S. Pat. No. 9,521,811 has been proven to be extremely successful in the marketplace. However, as one makes products, one often discovers that improvements could be made to those designs. Furthermore, accessories to successful products may also be desirable for certain applications.

In traditional gardening techniques, trellises are often constructed as vertically supported elevated concentric rings, often for tomatoes, one example of such being U.S. Pat. No. 1,635,071. There are many welded constructions similar thereto in the marketplace today.

Many trellises sold in the marketplace, including U.S. Pat. No. 2,763,096 and others, have legs which extend into the soil with the plant. The upper portion(s) of the trellis then support at least some of the weight of the plant on the trellis structure extending above the legs. The wire cage members 220 of U.S. Pat. No. 9,521,811 provide such a construction as well.

One improvement to this prior typical art construction is U.S. Pat. No. 2,083,678. This design clamps onto the rim of the bucket and then upwardly extends the trellis structure from that circumferential ring-frame structure clamped completely about the bucket rim. While this is certainly one way of providing a trellis on a round-rimmed bucket structure, it would not appear to work well for a non-round upper rim planter. Additionally, it may be that there may still be improvements for trellis systems utilized with round rims. Accordingly, there is believed to be a need for an improved trellis system over the disclosed prior art.

### SUMMARY OF THE INVENTION

Accordingly, it is an object of many embodiments of the present invention to provide an improved trellis.

It is another object of many embodiments of the proposed invention to provide an improved trellis for use with plant towers such as U.S. Pat. No. 9,521,811.

It is another object of many embodiments of the present invention to provide an improved trellis system having spaced apart, cantileveredly extending arms connected at one or more locations to one or more upper rims of container(s). The arms connect to a radially distant ring which provides a continuous circumferentially oriented perimeter ring (not necessarily round) about the container, or containers, for supporting plants at about or above a level of the rim and/or potentially supporting additional circumferentially oriented ring levels above the first level.

Accordingly, in accordance with a presently preferred embodiment of the present invention, many embodiments of the present invention provide, possibly with segmented construction, a trellis ring that can be cantileveredly supported by or otherwise connected to one or more plant containers. In fact, successive rings may be connected in at least one of a vertically supported or cantileveredly connection to containers to provide elevationally spaced rings.

Furthermore, with some segmented constructions, a ring segment can cantileveredly connect at ends, possibly within a groove, of an adjacent segment and then possibly snap together, preferably with a snap connection for at least some embodiments.

Furthermore, it may be that when utilizing cantileveredly extending arm(s), the arm(s) may connect to a rim or other structure of one or more plant containers possibly a plant tower such as U.S. Pat. No. 9,521,811, preferably with a cantileveredly, if not a snap connection, of the arm to the container(s). Such connections provide an easy to assemble trellis system for a user to be able to provide a relatively quick and satisfying user experience to construct a stable trellis which can be shipped as component parts and assembled on location in a quick and easy manner by a consumer or other party.

Accordingly, in accordance with a presently preferred embodiment of the present invention, a trellis system may be provided with a plurality of arms such as at least two, and possibly six, or any other appropriate number, to cooperate with a plant tower such as U.S. Pat. No. 9,521,811 (or other container) so that arms can connect and/or snap and/or otherwise cantileveredly extend away from the plant container(s) at a particular level along and/or from upper rims of containers having openings at the same planar elevation. The arm(s) then extend radially outwardly therefrom.

Connected at an unsupported ends of the arm or other portions of the arm are preferably a plurality of ring segments which cooperate with one another to form a continuous perimeter ring when connected together. Ring segments may preferably have a cantileveredly attachment at one end and/or a snap. The cantileveredly ring attachment may be received in a groove at an angle and then pushed down to provide a ring, possibly planar at the connection. Snap connections may also be utilized to assist the ring segments to form a rigid ring when the pre-determined number of segments are connected together. The ring can have a continuous outer perimeter when assembled. Some ring segments can be connected to other rings with extension posts which can vertically extend from a ring to then be received by another ring at a higher vertical elevation (which could then also be receive another set of extension posts), etc.

For plant towers, such as U.S. Pat. No. 9,521,811, since each container, or set of containers, along a level can support a ring with arms, it may be possible to connect multiple sets of rings with arms vertically above another one until the topmost level is reached at which time one or more extension post levels may be installed for successive additional vertical levels with rings atop the extension post level(s). Utilizing the arms and the rings, various structures for plants such as tomatoes and/or other plants may connect thereto for elevational support or otherwise be supported as would be understood by those or ordinary skill in the art.

### BRIEF DESCRIPTION OF THE DRAWINGS

The particular features and advantages of the present invitation will become apparent from the following description when considered in conjunction with the accompanying drawings in which:

FIG. 1 is a side perspective view of a presently preferred embodiment of the present invention in an installed configuration connected to a container illustrated as a plant tower;

FIG. 2 is a top perspective view of a ring assembly as shown in FIG. 1 removed from a container type structure;

FIG. 3 is a top perspective view showing the uppermost trellis structure shown in FIG. 1;

FIG. 4 is a top perspective view showing an uppermost trellis ring structure as shown in FIGS. 1-3;

FIG. 5 is a top perspective view showing a ring segment used to construct the ring of FIG. 4;

FIG. 6 is a top perspective view showing the arm as is shown in FIG. 1-3;

FIG. 7 shows a partial cross sectional view of the trellis structure shown in FIG. 3 taken along the line E-E;

FIG. 8 shows detail F from FIG. 7;

FIG. 9 shows detail I from FIG. 7;

FIG. 10 shows a top perspective view of a connection of adjacent ring segments to form the rings of FIGS. 1-4;

FIG. 11 shows a cross-sectional view taken along the line Z-Z of FIG. 10;

FIG. 12 shows a bottom perspective view of a connection of an arm to a ring segment as occurs in FIGS. 1-4;

FIG. 13 shows a top plan view of the connection shown in FIG. 12;

FIG. 14 is a cross section view taken along line A-A of FIG. 13;

FIG. 15 shows detail B shown in FIG. 14;

FIG. 16 shows a bottom plan view of an arm connected to a container of the preferred embodiment;

FIG. 17 shows a cross section view taken along the line C-C of FIG. 16; and

FIG. 18 shows a bottom perspective view of a portion shown in FIG. 16.

### DETAILED DESCRIPTION OF THE PREFERRED EMBODIMENT

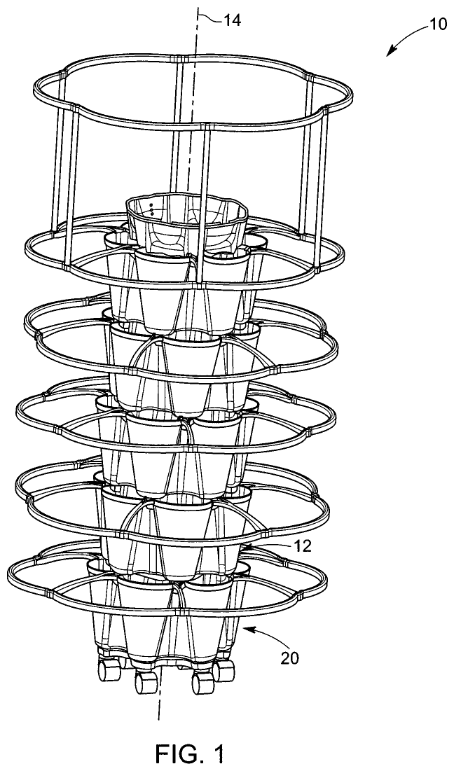

FIG. 1 shows a trellis system 10 as connected to a plant tower 12 such as is shown in U.S. Pat. No. 9,521,811, incorporated herein by reference in its entirety. In the '811 patent, optional wire cage members 220 could be positioned at the edges of the lobes 40 of the plant container modules 20. While that construction certainly works for its intended purpose, the applicant has developed what they believe to be a more desirable design for many applications.

While the trellis system 10 of the preferred embodiment works particularly well with the prior art plant tower 12, the trellis system technology can be utilized with other containers as will be described in further detail below.

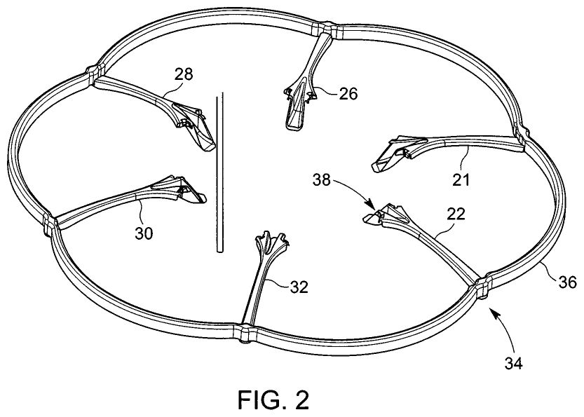

The trellis system 10 has a plurality of components as can be seen in the various figures. Specifically, FIG. 2 shows arms 22, 24, 26, 28, 30, 32. Each of these arms 22-32, if utilized is connected for at least the preferred embodiment at a first end 34 of the respective arm 22-32 to first ring 36. Second end 37 of arm 22 is available for connection to a container such as one of the plant container modules 20 of the plant tower 12 as will be described in further detail below, preferably in a cantilevered manner, or other appropriate container. As can be seen by FIG. 2, the first ring 36 has a continuous outer perimeter which could install such as is shown in FIG. 1. First ring 36 preferably circumnavigates a plant container module 20 in a continuous and uninterrupted fashion for preferred embodiments and can be aligned a central axis 14 of both the first ring(s) 36 as well as the plan container module(s) 20 and/or the plant tower 12. Construction of the first ring 36 and other rings will be described in further detail below.

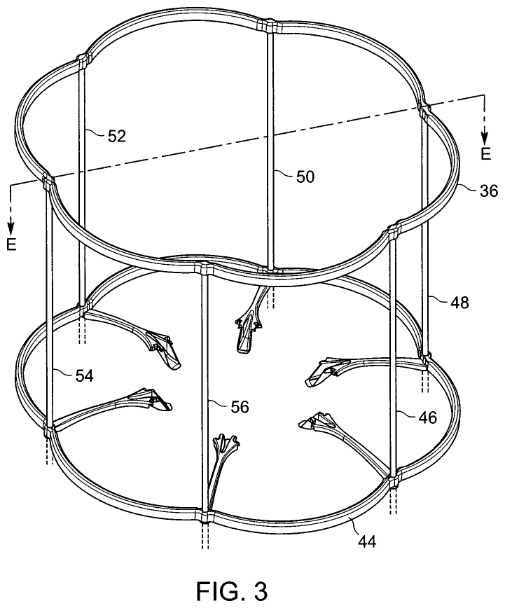

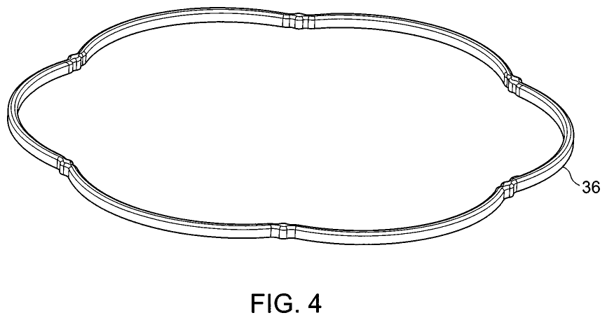

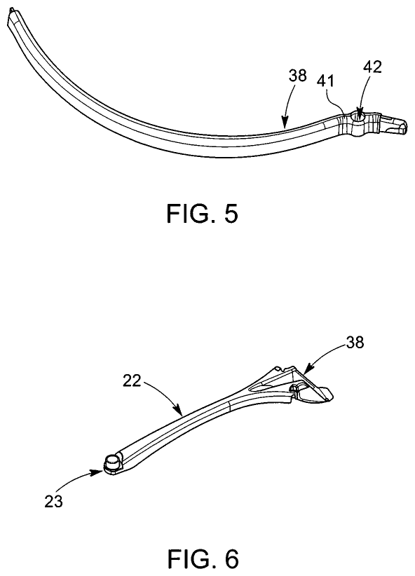

The first ring 36, as well as other rings, could also preferably be made in segments such as ring segment 38 shown in FIG. 5 and others. This ring segment 38 may have an optional hole 42 in an upper surface 41 which may not be present in all of the segments 34 such as the segment forming the first ring 36, but is present with other rings such as the second ring 44 shown in FIG. 3 which can be used for at least some embodiments. Furthermore, multiple second rings 44 could be utilized as will be indicated by the phantom lines showing the possible use of additional levels of extension posts 46, 48, 50, 52, 54, and 56. With the posts 46, 48, 50, 52, 54, 56 inserted into the holes 42 of the ring segments 38 when provided, the ability then to connect the first ring 36 to second rings 44 can then be provided. Furthermore, with such connections, additional second rings 44 could be connected in multiple levels of rings, with a top most second ring 44 then terminating, possibly with a first ring 36 above it as would be understood by those of ordinary skill in the art.

FIG. 6 shown an exemplary arm 22 as can be utilized with a presently preferred embodiment. Other arms 22, 24, 26, 28, 30, and or 32 and possibly others could be utilized with other embodiments.

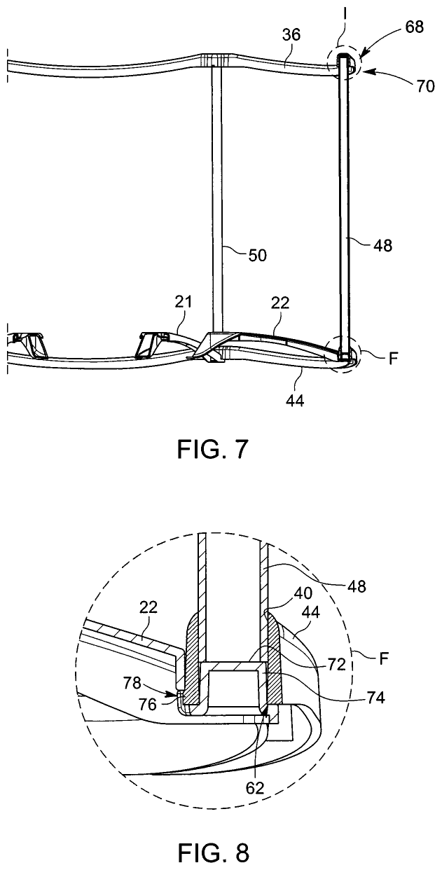

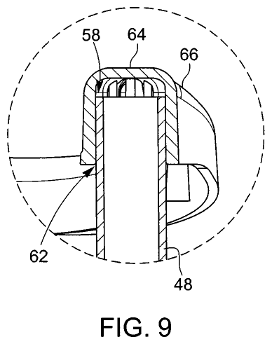

FIG. 7 shows a side view in cross-sectional representation of the structure shown in FIG. 3 taken along the line E-E. This construction has a post 48 being received in a hole 42 and having a terminal end 58 and being received within bore 62 of the first ring 36. This construction may provide a substantially planar surface above the surface 64 by the bore 62 with adjacent surface 66. The first ring 36 need not be planar for all embodiments, but instead could provide a first elevation 68 at the surface 64 and a second elevation 70 at a different location along the ring 36 and/or ring portion or segment 38 such as illustrated. In the illustrated embodiment, the first elevation 68 is higher than the second elevation 70 which is located about at a mid-point of the ring segment 38 which would be exactly between adjacent surfaces 64 which are above the extension posts 46, 48, 50, 52, 54, 56.

FIG. 8 shows the second ring 44 which could have similarly constructed ring portions as the ring segments 38 of the first ring 36. In this embodiment, holes 44 extend at least partially through the second ring 44 for at least some embodiments. This can assist as will be explained below as it relates to the connection of the arm such as arm 22 to the bore 62 to then be able to support the various extension posts 46, 48, 50, 52, 54, 56 thereupon. In fact the extension post 48 can contact an upper surface 72 of a base 74 which may preferably be received within the bore 62. In fact, the construction of the bore 62 as well as the arm 22 can facilitate this connection. The construction of the second ring 44 as well as the arm 22 may allow the arm 22 to receive a snapped in second ring 44 as will be explained in further detail below. Such a construction works not only with second ring 44 but also the first rings 36 for many embodiments.

Specifically, first snap 76 is being received within cutout 78 when installed so that there is resistance to being able to remove the arm 22 relative to the second ring 42 when installed as shown to assist in providing a rigid construction. First snaps 76 or other snaps could be provided to secure the extension rods 46, 48, 50, 52, 54, 56 to the first and/or second rings 36 and/or 44 as well for various embodiments. This also may add to rigidity. Other extension rods 46-56 may be able to be threadedly connected or otherwise connect. Furthermore, gravity may be utilized such as shown to at least assist in retaining the structure.

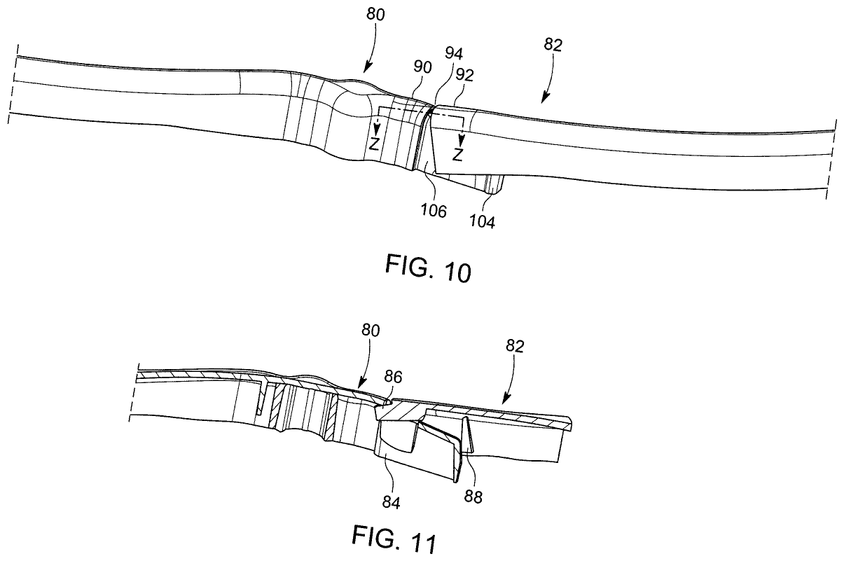

When connecting a first ring segment 80 to an adjacent ring segment 82 shown in FIGS. 10 and 11 regardless of whether they are first or second rings 36,44, locking connections can be provided as shown to assist in providing a pleasant user experience particularly in ease of assembly and sturdiness (or rigidity) of the assembled product.

Specifically, the first ring portion 80 may have a groove 84 into which leg 86 or the second ring portion 82 is inserted and then pivoted into place so that second snap 88 (if utilized) can lock the first and second ring portions 80,82 in the arrangements as shown in FIG. 1, 2, 3 and others. Leg 94 is preferably sufficiently received in a groove 84 so that continuous upper surfaces 90,92 may be maintained where its instantaneously planar across the interface 94 when connected, for at least some embodiments.

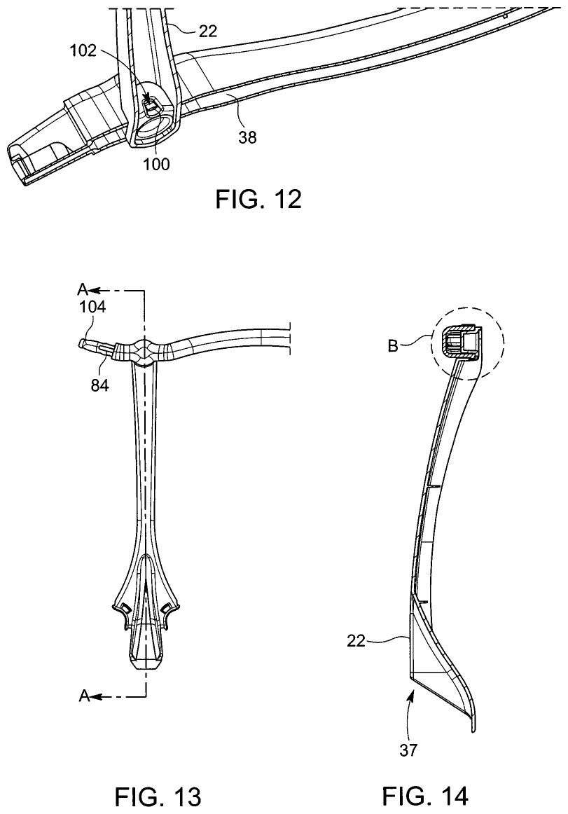

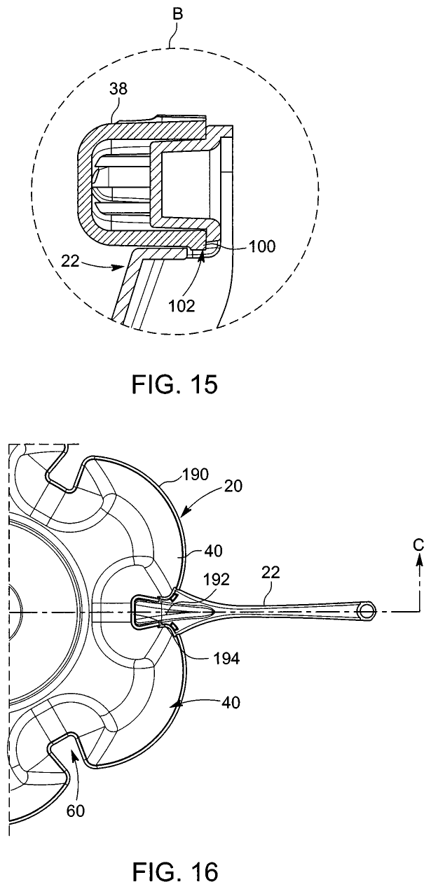

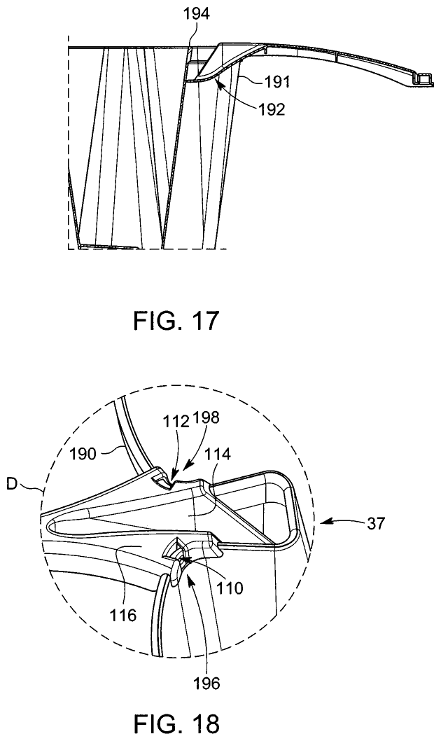

FIGS. 12-15 show a connection of an exemplary arm 22 to a ring segment 38 with a third snap 100 (if utilized) received in cutout 102 when fully installed. This is shown better with detail of FIG. 14 and can also assist in providing rigidity. Leg 86 may fit within the groove 84 while also providing shoulder 104 to assist in supporting the end 106 of the second ring segment 82. This then may allow the second end 37 of arm 22 to be connected to the container such as the plant container module 20 or other appropriate container depending on the construction of the end 37 of the arm 22 and others. With this construction plant tower 12 remember that the plant container module 20 has lobes 40 spaced by indentations 60.

FIG. 16 shows a plant container module 20 with an arm 22 connected thereto. For many embodiments, the containers such as a plant container module 20 or even a bucket, will have a downwardly extending lip 190 possibly spaced from a sidewall 191 (if not a part of the sidewall 191). The arm 22 may have a foot 192 which can extend against a wall 194 such as a wall of an indentation 60 of container, or against any other exterior portion of sidewall 191 wall of a container 20.

The arm 22 can have shoulders 196,198 which extend over the lip 190 and may even provide one or more snap connections such as by receiving lip 190 within cutouts 110,112 to firmly secure the arm 22 to the plant container module 20. The arms 22 may have a groove 114 from the top extending downwardly from upper surface 116 at the second end 37 and proceed downwardly to the foot 192 and spaced apart shoulders 196,198 for at least some embodiments so that the shoulders 196,198 may be spaced apart by the groove 114. Other embodiments may not have this construction and may even have a single shoulder 192 or 198 extending above the foot 192. Still other embodiments may have other constructions.

The arms 22 preferably extend at about a plane of lip 190 of the plant container module 20 (or opening of a planter if of a different construction). The first ring 36 (a second ring 44) can then be radially spaced outwardly relative to a perimeter of the container (such as plant container module 20). A ring (either first or second ring 36,44) can then be located above the first ring 36 (or second ring 44). This can assist in providing a multi-level ring structure above at least a lower-most plant container module 20. The more rings (36 of 44) can be utilized to support plants. Preferably, all of the rings (36 and/or 44) are co-axially oriented relative to axis 44 and, at least some, if not all, extend radially outwardly of exterior plant container modules 20.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the intention are intended to be included within the scope of the appended claims.

Having thus set forth the nature of the invention, what is claimed herein is:

1. A trellis structure comprising:
a container having an upper lip defining a perimeter;
a first ring circumnavigating the perimeter of the upper lip of the container;
an arm connected to the first ring and connected to the upper lip of the container spacing the first ring external to the perimeter of the upper lip of the container.

2. The trellis structure of claim 1 wherein the arm has a first end connected to the first ring.

3. The trellis structure of claim 2 wherein the arm has a second end opposite the first end, and the second end is connected to the upper lip of the container.

4. The trellis structure of claim 1 wherein the arm is cantileveredly connected to the upper lip of the container.

5. The trellis structure of claim 4 wherein the arm has a second end with at least one shoulder contacting the upper lip of the container.

6. The trellis structure of claim 5 further comprising a foot contacting an exterior surface of the container below the shoulder.

7. The trellis structure of claim 6 wherein the at least one shoulder is first and second shoulders spaced apart from one another.

8. The trellis structure of claim 7 wherein the foot extends farther from a first end of the arm, opposite the second end of the arm, than the first and second shoulders.

9. The trellis structure of claim 8 wherein the first and second shoulders snap connect to the upper lip of the container.

10. The trellis structure of claim 1 wherein the first ring extends at least partially above the upper lip of the container.

11. The trellis structure of claim 1 wherein the first ring extends at least partially below the upper lip of the container.

12. The trellis structure of claim 10 further comprising a second ring connected to the first ring and extending above the upper lip of the container while circumnavigating the perimeter of the upper lip.

13. The trellis structure of claim 12 further comprising an extension post connected to the first ring and the second ring at least assisting in supporting the second ring above the first ring.

14. The trellis structure of claim 13 wherein the extension post is one of a plurality of extension posts upwardly extending from the first ring to support the second ring above the first ring.

15. The trellis structure of claim 12 further comprising a plurality of second rings connected to the first ring and extending above the upper lip of the container while circumnavigating the perimeter of the upper lip.

16. The trellis structure of claim 1 wherein the first ring is comprised of ring segments connected together to form the first ring and the ring segments have a hole in an upper surface receiving an extension post, said extension post connected to a second ring supported above the first ring and circumnavigating the perimeter of the container.

17. The trellis structure of claim 16 wherein the ring segments have a leg received in a groove of an adjacent segment which is biased in place when connected to an adjacent ring segment.

18. The trellis structure of claim 1 wherein the arm is one of a plurality of arms extending from the upper lip of the container and connected to the first ring.

19. The trellis structure of claim 1 wherein the container has a plurality of connected pockets forming the perimeter of the container at a first level.

20. The trellis structure of claim 1 wherein the first level is one of a plurality of levels of a vertical garden, and the first ring is one of a plurality of first rings, each of the first rings connected by arms to respective levels of the vertical garden.
